(19) United States
(12) Patent Application Publication
(10) Pub. No.: US 2013/0069453 A1
(43) Pub. Date: Mar. 21, 2013

(54) MECHANICALLY COMMUTATED SWITCHED RELUCTANCE MOTOR

(71) Applicants: Sung Tai JUNG, Gyunggi-do (KR); Hae Jun YANG, Gyunggi-do (KR); Hyung Joon KIM, Seoul (KR); Ki Young LEE, Gyunggi-do (KR)

(72) Inventors: Sung Tai JUNG, Gyunggi-do (KR); Hae Jun YANG, Gyunggi-do (KR); Hyung Joon KIM, Seoul (KR); Ki Young LEE, Gyunggi-do (KR)

(73) Assignee: SAMSUNG ELECTRO-MECHANICS CO., LTD., Gyunggi-do (KR)

(21) Appl. No.: 13/340,459

(22) Filed: Dec. 29, 2011

(30) Foreign Application Priority Data
Sep. 20, 2011 (KR) 10-2011-0094650

(51) Int. Cl. H02K 21/44

(52) U.S. Cl. 310/46

(57) ABSTRACT

Disclosed herein is a switched reluctance motor including: a salient pole type rotor; and a stator including a stator body, a plurality of phase windings, permanent magnets, and magnetic flux transform coils wound to enclose the permanent magnets, wherein magnetic fluxes generated by excitation of the phase windings interact with magnetic force generated from the permanent magnets, such that a magnetic flux amount may increase and torque density may be improved, an intersection line is not generated in the magnetic fluxes generated by the excitation of the phase windings, and the magnetic fluxes are reduced by the magnetic flux transform coil.

### CROSS REFERENCE TO RELATED APPLICATION

This application claims the benefit of Korean Patent Application No. 10-2011-0094650, filed on Sep. 20, 2011, entitled “Mechanically Commutated Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

In a general switched reluctance motor, both of a stator and a rotor have a salient pole type magnetic structure. In addition, the stator has a concentrated type coil wound therearound, and the rotor is configured only of an iron core without any type of excitation device (a winding, a permanent magnet, or the like), such that a competitive cost is excellent. Further, a speed changeable switched reluctance motor stably generates a continuous torque with the aid of a converter using a power semiconductor and a position sensor and is easily controlled to be appropriate for performance required in each application.

In the case of various alternate current (AC) motors (an induction motor, a permanent magnet synchronous motor, or the like) and a brushless direct current (DC) motor, when a significant improvement in performance is required with the passage of time after design of one electromagnetic field structure is completed, the electromagnetic field structure should be re-designed as a new electromagnetic field structure. Otherwise, there is no way except for a simple design change replacing a high cost material such as steel, a permanent magnet, or the like, which is not an efficient design. The switched reluctance motor also has the above-mentioned problem.

More specifically, the switched reluctance motor according to the prior art includes a rotor and a stator including salient poles, wherein coils are wound around the salient poles to thereby form a phase winding. When a current is applied to the phase winding, a magnetic field is generated and attractive force is generated between the salient pole of the stator and the rotor, such that the rotor rotates.

In addition, a plurality of salient poles are formed in the stator, the coils are wound around the plurality of salient poles to form a plurality of phase windings, and each of the plurality of phase windings is excited to generate a torque, thereby rotating the rotor. However, in the switched reluctance motor according to the prior art, since only the windings are excited to generate the torque, torque density, efficiency, and the like, are limited. In addition, when the switched reluctance motor according to the prior art is implemented as a switched reluctance motor having a plurality of phases, core less increases due to intersection of a magnetic flux and high speed operation may not be easily implemented.

### SUMMARY OF THE INVENTION

The present invention has been made in an effort to provide a switched reluctance motor in which a permanent magnet is mounted between phase windings and a magnetic flux transform coil is wound around the permanent magnet, wherein magnetic fluxes generated by excitation of the phase windings interact with magnetic force generated from the permanent magnets, such that a magnetic flux amount may increase and torque density may be improved, an intersection line is not generated in the magnetic fluxes generated by the excitation of the phase windings, such that more efficient implementation may be performed, and the magnetic fluxes are reduced by the magnetic flux transform coil, such that a torque may be reduced and high speed operation may be easily implemented.

According to a preferred embodiment of the present invention, there is provided a switched reluctance motor including: a salient pole type rotor provided with a plurality of salient poles; and a stator including a stator body provided with a plurality of salient poles facing the rotor, a plurality of phase windings formed by winding coils around the salient poles, permanent magnets mounted between the phase windings, and magnetic flux transform coils wound to enclose the permanent magnets.

The stator body may be provided with a plurality of auxiliary slots positioned between the salient poles, the permanent magnets may be positioned to be adjacent to the auxiliary slots, and the coils may be wound to enclose the auxiliary slots.

Directions in which the coils are wound around the plurality of auxiliary slots may repeatedly intersect with each other.

The plurality of auxiliary slots may be slots formed from an inner diameter of the rotor body to an outer diameter thereof.

The permanent magnets may be disposed to generate magnetic force in the same direction as a direction in which magnetic fluxes are generated from the phase windings.

The magnetic flux transform coils may be disposed to generate magnetic force in an opposite direction to a direction in which magnetic fluxes are generated from the phase windings.

The magnetic flux transform coils may have direct current (DC) or alternate current (AC) voltage applied thereto at the time of high speed operation of the switched reluctance motor.

Each of the permanent magnets may include: two first permanent magnets mounted on an outer peripheral portion of the stator body in a radial direction; and a single second permanent magnet mounted on an inner peripheral portion of the stator body in the radial direction, wherein the second permanent magnet is positioned between the two first permanent magnets.

The plurality of salient poles formed in the stator may be protruded inwardly in a radial direction so as to face the rotor and are disposed at equipitch in a circumferential direction.

Directions in which the coils are wound around the plurality of salient poles of the stator may repeatedly intersect with each other.

Six salient poles of the rotor may be formed at equipitch in a circumferential direction of the rotor, four salient poles of the stator body may be formed at equipitch in the circumferential direction of the rotor body, the phase windings may be formed as two-phase windings formed by winding the coils around the salient poles, four auxiliary slots may be formed between the salient poles, and the magnetic flux transform coils may be wound around the auxiliary slots.

Ten salient poles of the rotor may be formed at equipitch in a circumferential direction of the rotor, six salient poles of the stator body corresponding to the salient poles of the rotor may be formed at equipitch in the circumferential direction of the rotor body, the phase windings may be formed as three-phase windings formed by winding the coils around the salient poles, six auxiliary slots may be formed between the salient poles, and the magnetic flux transform coils may be wound around the auxiliary slots.

### BRIEF DESCRIPTION OF THE DRAWINGS

FIG. 1 is a schematic configuration view of a switched reluctance motor according to a first preferred embodiment of the present invention;

FIG. 2 is a schematic graph for selective operation of the switched reluctance motor according to the preferred embodiment of the present invention;

FIG. 3 is a schematic use state view showing magnetic flux distribution at the time of excitation of a first-phase winding in the switched reluctance motor shown in FIG. 1;

FIG. 4 is a schematic use state view showing magnetic flux distribution at the time of excitation of a second-phase winding in the switched reluctance motor shown in FIG. 1; and

FIG. 5 is a schematic configuration view of a switched reluctance motor according to a second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a switched reluctance motor according to preferred embodiments of the present invention will be described with reference to the accompanying drawings.

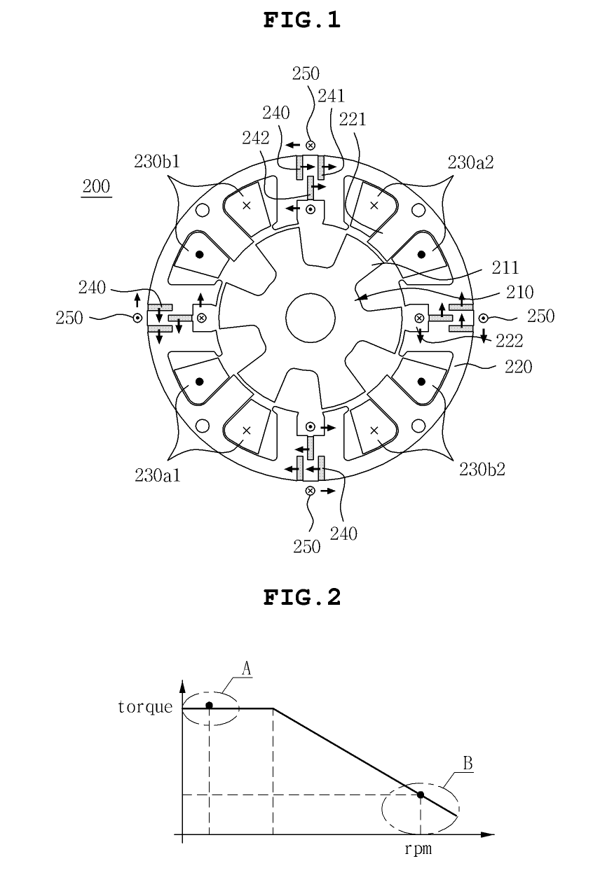

FIG. 1 is a schematic configuration view of a switched reluctance motor according to a first preferred embodiment of the present invention. As shown, the switched reluctance motor 200 includes a rotor 210 and a stator, wherein the rotor 210 rotates by electromagnetic force with the stator.

More specifically, the rotor 210 is rotatably disposed at an inner side of the stator and is implemented as a salient pole type rotor including a plurality of salient poles 211 formed at an outer peripheral portion thereof in a radial direction. In addition, six salient poles 211 of the rotor are formed at equipitch in a circumferential direction of the rotor.

Further, the stator includes a stator body 220, phase windings 230a1, 230a2, 230b1, and 230b2, permanent magnets 240, and magnetic flux transform coils 250.

In addition, the permanent magnets 240, which are to improve torque density by adding their magnetic force to magnetic fluxes generated by excitation of the phase windings 230a1, 230a2, 230b1, and 230b2, are positioned between the plurality of phase windings 230a1, 230a2, 230b1, and 230b2, are mounted in the stator body 220, and are disposed so as to generate magnetic force in the same direction as a direction in which the magnetic fluxes are generated from the phase winding.

In addition, the stator body 220 is provided with a plurality of salient poles 221 protruded inwardly in the radial direction so as to face the rotor and disposed at equipitch in the circumferential direction, wherein the salient poles 221 includes a plurality of auxiliary slots 222 formed therebetween.

Further, coils are wound to enclose the plurality of salient poles 221 of the stator body 220 to thereby form the phase windings 230a1, 230a2, 230b1, and 230b2. In addition, directions in which the coils are wound around the plurality of salient poles 221 of the stator repeatedly intersect with each other.

Further, the permanent magnets 240 are disposed to generate magnetic force in the same direction as a direction in which the magnetic fluxes are generated from the phase windings 230a1, 230a2, 230b1, and 230b2. In addition, the number of permanent magnets 240 according to the preferred embodiment of the present invention is not limited. However, it is preferable that three permanent magnets are mounted between every two phase windings 230a1, 230a2, 230b1, and 230b2 of the stator body, two first permanent magnets 241 are mounted on an outer peripheral portion of the stator body in the radial direction, a single second magnet 242 is mounted on an inner peripheral portion of the stator body in the radial direction, and the second permanent magnet 242 is positioned between the two first permanent magnets 241, in consideration of the intensity of the magnetic force. Further, the second permanent magnet 242 is positioned on an inner peripheral surface of the stator body 220 in contrast with the first permanent magnet 241.

In addition, the magnet flux transform coils 250 is to selectively apply voltage to reduce intensity of a magnetic flux, thereby reducing a torque and implementing high speed operation.

To this end, the plurality of auxiliary slots 222 include the magnetic flux transform coils 250 formed in the radial direction of the stator body 220, that is, from an inner diameter of the stator body to an outer diameter thereof so as to be wound around the inner diameter and the outer diameter thereof. In addition, coils are wound around the auxiliary slots 222 in the radial direction of the stator body 220 so as to enclose the permanent magnets. Further, directions in which the magnetic flux transform coils 250 are wound around the plurality of auxiliary slots 222 repeatedly intersect with each other. This is to form the magnetic flux transform coils 250 so as to correspond to the permanent magnets 240 mounted so that magnetic directions thereof intersect with each other, thereby reducing magnetic force of the permanent magnets.

FIG. 1 shows a two-phase switched reluctance motor in which six salient poles 221 of the rotor are formed at equipitch in the circumferential direction of the rotor and four salient poles 221 of the stator body 220 are formed. In addition, each of the coils is concentratedly wound around four salient poles 221, such that two-phase phase windings 230a1, 230a2, 230b1, and 230b2 having an A phase winding and a B phase winding, are formed. In addition, four auxiliary slots 222 are formed between the salient poles 221 of the stator.

The above-mentioned configuration, the switched reluctance motor 200 according to the preferred embodiment of the present invention direct current (DC) voltage or alternate current (AC) voltage to the magnetic flux transform coil 250 at the time of low speed and high torque operation (A) thereof to weaken a magnetic flux and reduce a torque, such that it may be transformed into high speed and low torque operation B, as shown in FIG. 2.

As described above, the switched reluctance motor 200 shown in FIG. 1 is a two-phase switched reluctance motor. An even-phase switched reluctance motor corresponding to 2n-phase (n indicates a positive integer) is configured so that directions of magnetic fluxes by the permanent magnet and excitation of the phase winding interact with each other as in the switched reluctance motor shown in FIG. 1.

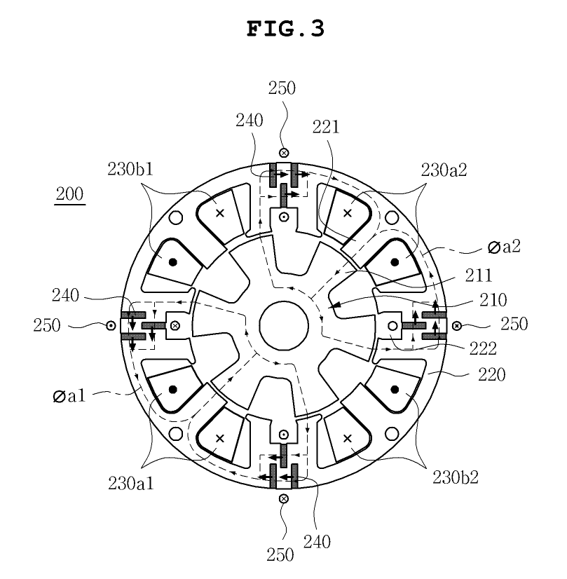

FIG. 3 is a schematic use state view showing magnetic flux distribution at the time of excitation of a first-phase winding in the switched reluctance motor shown in FIG. 1.

As shown, in the switched reluctance motor 200, when A phase windings 230a1 and 230a2, which are first-phase windings, of the phase windings have a current applied thereto to be excited, magnet fluxes are generated. More specifically, the magnetic fluxes (Φa1 and Φa2) are generated by magnetic fluxes of the A phase windings 230a1 and 230a2 and magnetic force of the permanent magnets 240. Here, directions of the magnetic force of the permanent magnets 240 are the same as those of the magnetic fluxes generated in the A phase windings 230a1 and 230a2 as shown by an arrow in FIG. 2, such that torque density is improved and an intersection line is not generated in the magnetic fluxes at any position of the stator, thereby reducing core loss. That is, the magnetic flux has a short path, such that an inductance increases. Furthermore, due to the permanent magnet, a magnetic flux amount increases and attractive force is improved, such that the rotor rotates. In addition, various permanent magnets according to magnetic force are adopted, thereby making it possible to vary torque density.

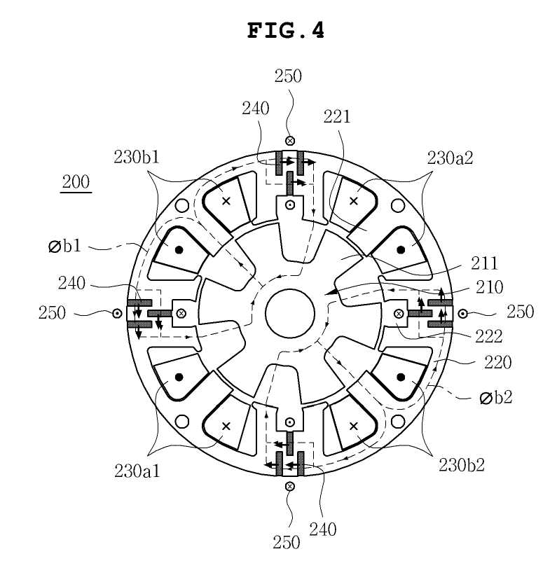

FIG. 4 is a schematic use state view showing magnetic flux distribution at the time of excitation of a second-phase winding in the switched reluctance motor shown in FIG. 1. As shown, in the switched reluctance motor 200, when B phase windings 230b1 and 230b2, which are second-phase windings, of the phase windings have a current applied thereto to be excited, magnetic fluxes (Φb1 and Φb2) are generated. In this case, directions of the magnetic force of the permanent magnets 240 are the same as those of the magnetic fluxes generated in the B phase windings 230b1 and 230b2, such that torque density is improved. In addition, various permanent magnets according to magnetic force are adopted, thereby making it possible to vary torque density.

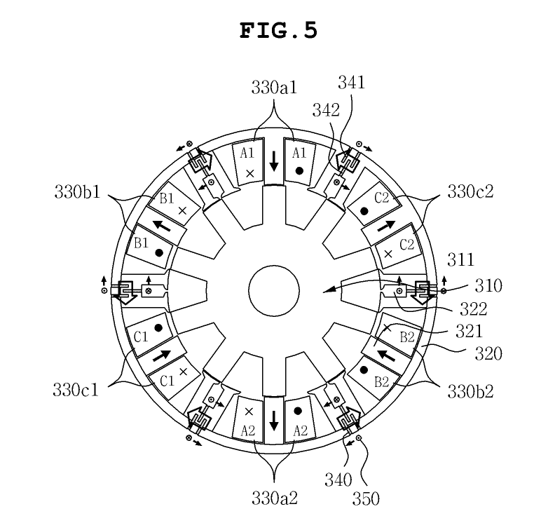

FIG. 5 is a schematic configuration view of a switched reluctance motor according to a second preferred embodiment of the present invention. As shown, the switched reluctance motor 300 is implemented as a three-phase switched reluctance motor, in contrast with the switched reluctance motor 200 according to the first preferred embodiment of the present invention shown in FIG. 1.

To this end, the switched reluctance motor 300 is configured to include a rotor 310 and a stator including a stator body 320, phase windings 330, permanent magnets 340, and magnetic flux transform coils 350.

More specifically, the rotor 310 is rotatably disposed at an inner side of the stator and is implemented as a salient pole type rotor including a plurality of salient poles 311 formed at an outer peripheral portion thereof in a radial direction. In addition, ten salient poles 311 of the rotor are formed at equipitch in a circumferential direction of the rotor.

Further, six salient poles 321 of the stator body 320 are formed, and each of the coils is concentratedly wound around six salient poles 321, such that three-phase phase windings 330a1, 330a2, 330b1, 330b2, 330c1, and 330c2 having a U phase winding, a V phase winding, and a W phase winding are formed, and a plurality of auxiliary salient poles 322 are formed between the plurality of salient poles 321.

Further, the permanent magnets 340 are disposed to generate magnetic force in the same direction as a direction in which the magnetic fluxes are generated from the phase windings 330a1, 330a2, 330b1, and 330b2. In addition, the number of permanent magnets 340 according to the preferred embodiment of the present invention is not limited. However, three permanent magnets 340 are mounted between every two phase windings 330a1, 330a2, 330b1, and 330b2 of the stator body, two first permanent magnets 341 are mounted on an outer peripheral portion of the stator body in the radial direction, a single second magnet 342 is mounted on an inner peripheral portion of the stator body in the radial direction, and the second permanent magnet 342 is positioned between the two first permanent magnets 341, in consideration of the intensity of the magnetic force. Further, the second permanent magnet 342 is positioned on an inner peripheral surface of the stator body 320 in contrast with the first permanent magnet 341.

In addition, six auxiliary slots 322 are formed between the salient poles 321 and include coils wound therearound to form the magnetic flux transform coils 350. Further, the magnetic flux transform coils 350 are formed in the radial direction of the stator body 320, that is, from an inner diameter of the stator body to an outer diameter thereof so as to be wound around the inner diameter and the outer diameter thereof. In addition, coils are wound around the auxiliary slots 322 in the radial direction of the stator body 320 so as to enclose the permanent magnets. Further, directions in which the magnetic flux transform coils 350 are wound around the plurality of auxiliary slots 322 repeatedly intersect with each other. This is to mount the magnetic flux transform coils 350 so as to correspond to the permanent magnets 340 mounted so that magnetic directions thereof intersect with each other, thereby reducing magnetic force.

Through the above-mentioned configuration, the switched reluctance motor 300 allows directions of the magnetic fluxes to intersect with each other in a sequence of a U phase winding 330a1, a V phase winding 330b1, a W phase winding 330c1, a U phase winding 330a2, a V phase winding 330b2, and a W phase winding 330c2 in a counterclockwise direction, unlike the two-phase switched reluctance motor 200, such that intersection of the magnetic fluxes is not generated at any position. In addition, the permanent magnets 340 are mounted so that the magnetic force is generated in a direction corresponding to those of the magnetic fluxes of the phase windings 330a1, 330a2, 330b1, 330b2, 330c1, and 330c2, that is, the magnetic force is generated in a direction as shown by an arrow, thereby making it possible to improve torque density.

As described above, the switched reluctance motor 300 shown in FIG. 5 is the three-phase switched motor. This odd-phase switched reluctance motor may be designed so that directions of the permanent magnets and the magnetic fluxes are determined as in the switched reluctance motor 300 shown in FIG. 5.

Through the above-mentioned configuration, the intersection is not generated in the magnetic fluxes by the stator, thereby making it possible to reduce and improve torque density. In addition, a magnetic flux is reduced by the magnetic flux transform coil, thereby making it possible to reduce a torque and easily implement high speed operation.

According to the preferred embodiments of the present invention, it is possible to provide a switched reluctance motor in which a permanent magnet is mounted between phase windings and a magnetic flux transform coil is wound around the permanent magnet, wherein magnetic fluxes generated by excitation of the phase windings interact with magnetic force generated from the permanent magnets, such that a magnetic flux amount may increase and torque density may be improved, an intersection line is not generated in the magnetic fluxes generated by the excitation of the phase windings, such that more efficient implementation may be performed, and the magnetic fluxes are reduced by the magnetic flux transform coil, such that a torque may be reduced and high speed operation may be easily implemented.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a salient pole type rotor provided with a plurality of salient poles; and
a stator including a stator body provided with a plurality of salient poles facing the rotor, a plurality of phase windings formed by winding coils around the salient poles, permanent magnets mounted between the phase windings, and magnetic flux transform coils wound to enclose the permanent magnets.

2. The switched reluctance motor as set forth in claim 1, wherein the stator body is provided with a plurality of auxiliary slots positioned between the salient poles, the permanent magnets are positioned to be adjacent to the auxiliary slots, and the coils are wound to enclose the auxiliary slots.

3. The switched reluctance motor as set forth in claim 2, wherein directions in which the coils are wound around the plurality of auxiliary slots repeatedly intersect with each other.

4. The switched reluctance motor as set forth in claim 2, wherein the plurality of auxiliary slots are slots formed from an inner diameter of the rotor body to an outer diameter thereof.

5. The switched reluctance motor as set forth in claim 1, wherein the permanent magnets are disposed to generate magnetic force in the same direction as a direction in which magnetic fluxes are generated from the phase windings.

6. The switched reluctance motor as set forth in claim 1, wherein the magnetic flux transform coils are disposed to generate magnetic force in an opposite direction to a direction in which magnetic fluxes are generated from the phase windings.

7. The switched reluctance motor as set forth in claim 1, wherein the magnetic flux transform coils have direct current (DC) or alternate current (AC) voltage applied thereto at the time of high speed operation of the switched reluctance motor.

8. The switched reluctance motor as set forth in claim 1, wherein each of the permanent magnets includes:
two first permanent magnets mounted on an outer peripheral portion of the stator body in a radial direction; and
a single second permanent magnet mounted on an inner peripheral portion of the stator body in the radial direction,
the second permanent magnet being positioned between the two first permanent magnets.

9. The switched reluctance motor as set forth in claim 1, wherein the plurality of salient poles formed in the stator are protruded inwardly in a radial direction so as to face the rotor and are disposed at equipitch in a circumferential direction.

10. The switched reluctance motor as set forth in claim 1, wherein directions in which the coils are wound around the plurality of salient poles of the stator repeatedly intersect with each other.

11. The switched reluctance motor as set forth in claim 1, wherein six salient poles of the rotor are formed at equipitch in a circumferential direction of the rotor, four salient poles of the stator body are formed at equipitch in the circumferential direction of the rotor body, the phase windings are formed as two-phase windings formed by winding the coils around the salient poles, four auxiliary slots are formed between the salient poles, and the magnetic flux transform coils are wound around the auxiliary slots.

12. The switched reluctance motor as set forth in claim 1, wherein ten salient poles of the rotor are formed at equipitch in a circumferential direction of the rotor, six salient poles of the stator body corresponding to the salient poles of the rotor are formed at equipitch in the circumferential direction of the rotor body, the phase windings are formed as three-phase windings formed by winding the coils around the salient poles, six auxiliary slots are formed between the salient poles, and the magnetic flux transform coils are wound around the auxiliary slots.
